(19) United States
(12) Patent Application Publication
(10) Pub. No.: US 2017/0131395 A1
(43) Pub. Date: May 11, 2017

(54) DEVICES, SYSTEMS, AND METHODS FOR DETECTING GESTURES USING MULTIPLE ANTENNAS AND/OR REFLECTIONS OF SIGNALS TRANSMITTED BY THE DETECTING DEVICE

(71) Applicant: UNIVERSITY OF WASHINGTON, Seattle, WA (US)

(72) Inventors: Matthew S. Reynolds, Seattle, WA (US); Chen Zhao, Seattle, WA (US); Ke-Yu Chen, Seattle, WA (US); Shwetak N. Patel, Seattle, WA (US)

(73) Assignee: UNIVERSITY OF WASHINGTON, Seattle, WA (US)

(21) Appl. No.: 15/319,720

(22) PCT Filed: Jun. 25, 2015
(86) PCT No.: PCT/US15/37813

§ 371 Date: Dec. 16, 2016

Related U.S. Application Data
(60) Provisional application No. 62/017,105, filed on Jun. 25, 2014.

(51) Int. Cl. G01S 13/56; G01S 7/41; G01S 13/00

(52) U.S. Cl. CPC G01S 13/56; G01S 13/003; G01S 7/415

(57) ABSTRACT

Examples described herein may detect gestures using multiple antennas and/or using reflected signals transmitted by the device which is also detecting the gesture. Multiple antenna detection may allow for classification of 3D gestures around a device. The use of reflected signals transmitted by the device itself may reduce a need for a separate signal source to be used for gesture detection. Accordingly, in some examples, devices (e.g. mobile phones) may detect gestures performed on or around the device without a need to transmit any signal specifically designed for gesture detection. Signals already transmitted by the device (e.g. GSM signals) may be used to detect the gestures.

### CROSS REFERENCE TO RELATED APPLICATION(S)

This application claims benefit under 35 U.S.C. §119(e) to U.S. provisional patent application Ser. No. 62/017,105, entitled “DETECTING GESTURES AROUND MOBILE DEVICES USING PASSIVE RADAR” filed Jun. 25, 2014, which provisional application is incorporated herein by reference in its entirety for any purpose.

### TECHNICAL FIELD

Examples described herein relate to detection of gestures. Examples include devices which may detect gestures using multiple antennas, using reflections of signals transmitted by the device, or combinations thereof.

### BACKGROUND

Space for touch screen interfaces is limited by what users are willing to carry. Although capacitive touch displays have effectively made the entire front face of most mobile devices interactive, occlusion remains an inherent problem. It may be difficult to expand the area available for existing capacitive sensors or front or back facing cameras or microphones. Proximity sensors may similarly be impractical on mobile devices because they may be occluded when a user holds the device. Magnetic sensing for inputs require a permanent magnet on the user's finger, which may impede adoption.

Many existing gesture recognition systems employ cameras or IR sensors which require line of sight access to the gesture. Such systems may perform differently under different lighting conditions and are limited to use when line of sight is available.

### SUMMARY

An example device may include a first antenna configured to receive a first communication signal and a second antenna configured to receive a second communication signal. The device may include at least one processing unit in communication with the first and second antennas, the at least one processing unit configured to receive the first and second communication signals. The at least one processing unit may be further configured to determine an amplitude modulation associated with each of the first and second communication signals and detect a gesture based on the amplitude modulation associated with each of the first and second communication signals.

The example device may include a transmit antenna positioned proximate the first and second antennas, and the first and second communication signals may be reflections of a signal transmitted by the transmit antenna.

An example method described herein includes transmitting a bursty communication signal, receiving at least one reflection of the bursty communication signal with at least one antenna, converting the at least one reflection of the bursty communication signal into a smoothed signal, and classifying the smoothed signal as corresponding to a gesture, based, at least in part, on an amplitude modulation associated with the smoothed signal.

The bursty communication signal may be a GSM signal.

Receiving may include receiving a plurality of reflections of the bursty communications signal at respective antennas of a plurality of antennas. Converting may include converting each of the plurality of reflections into a respective smoothed signal, and classifying may be further based, at least in part, on amplitude modulations associated with a plurality of the smoothed signals.

An example system includes a mobile device. The mobile device may include a first antenna configured to transmit a wireless communication signal, at least one processing unit coupled to the first antenna, an electrical port coupled to the at least one processing unit, and at least one computer readable medium coupled to the at least one processing unit and encoded with instructions executable by the at least one processing unit. The system may further include a case configured to at least partially enclose the mobile device. The case may include a plurality of antennas, an electrical connector coupled to the plurality of antennas, wherein the electrical connector is configured to connect with the electrical port to electrically connect the plurality of antennas to the at least one processing unit. The instructions executable by the at least one processing unit may include instructions for receiving reflections of the wireless communication signal at the plurality of antennas, and detecting a gesture based on amplitude modulations in the reflections of the wireless communication signal.

### BRIEF DESCRIPTION OF THE DRAWINGS

FIG. 1 is a schematic illustration of a device arranged in accordance with examples of the present disclosure.

FIG. 2 is a schematic illustration of an example antenna design which may be included in a case in examples described herein.

FIG. 3 is a flowchart illustrating a method according to examples described herein.

FIG. 4 is a schematic illustration of example gestures which may be detected in accordance with examples described herein.

FIG. 5 is a flowchart illustrating a method according to examples described herein.

FIGS. 6A-C are graphs illustrating an example process of identifying a signal segment corresponding to a gesture.

### DETAILED DESCRIPTION

Certain details are set forth below to provide a sufficient understanding of embodiments of the disclosure. However, it will be clear to one skilled in the art that embodiments of the disclosure may be practiced without various of these particular details. In some instances, well-known device components, circuits, control signals, timing protocols, and software operations have not been shown in detail in order to avoid unnecessarily obscuring the described embodiments of the disclosure.

Examples of devices, systems, and methods described herein may detect gestures using multiple antennas and/or using reflected signals transmitted by the device which is also detecting the gesture. Multiple antenna detection may allow for classification of 3D gestures around a device. The use of reflected signals transmitted by the device itself may reduce or eliminate need for a separate signal source to be used for gesture detection. Accordingly, in some examples, devices (e.g. mobile phones) may detect gestures performed on or around the device without a need to transmit any signal specifically designed for gesture detection. Signals already transmitted by the device (e.g. GSM signals) may be used to detect the gestures.

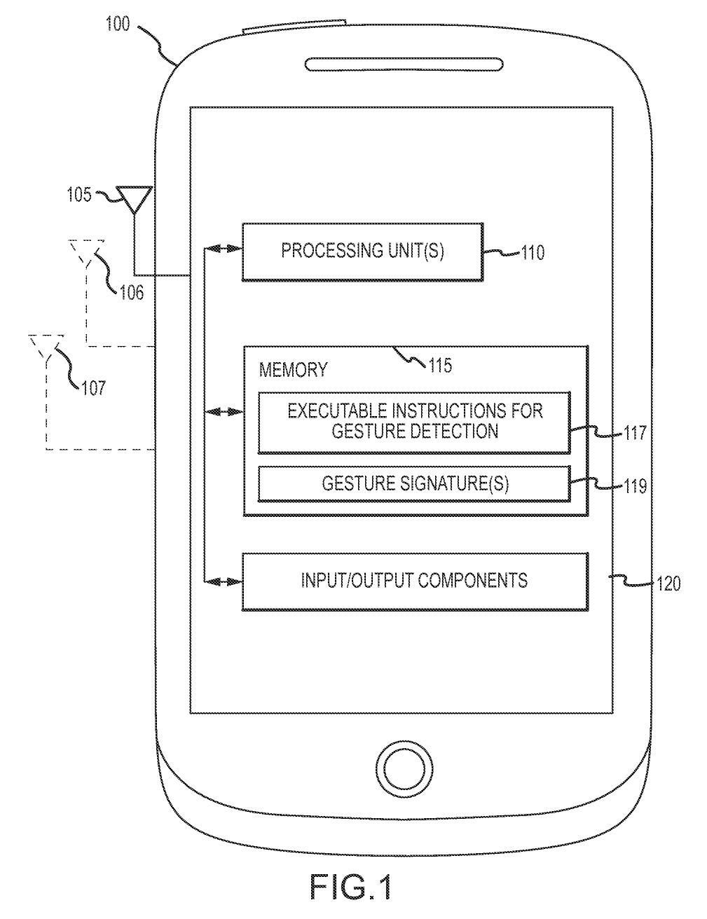

FIG. 1 is a schematic illustration of a device arranged in accordance with examples of the present disclosure. The device 100 includes an antenna 105, and optional additional antennas 106, 107. The device 100 includes at least one processing unit 110. The device 100 further includes a memory 115 which may be encoded with executable instructions for gesture detection 117. The memory 115 may further be encoded with gesture signature(s) 119. The device 100 may further include input/output components 120.

Any of a variety of devices may be used to implement the device 100, and the device 100 may provide a variety of functionalities in addition to the gesture detection described herein. In some examples, the gesture detection may be utilized by other functionalities of the device 100 (e.g. to control another application or other process programmed on the device 100 using a gesture detected as described herein). Example devices include, but are not limited to, computers (e.g. desktops, laptops, servers), tablets, phones, watches, wearable devices, appliances, and automobiles.

The device 100 includes processing unit(s) 110. The processing unit(s) 110 may be implemented using hardware suitable for conducting computations, such as one or more processors (including, e.g. multi-core processors). The device 100 includes and/or is in communication with memory 115. The memory 115 is in communication with the processing unit(s) 110. Generally, any computer readable medium (e.g. electronic memory) may be used to implement memory 115 including, but not limited to, RAM, ROM, FLASH, hard drive, solid state drive, Micro SD, or optical memory. It is to be understood that the arrangement of the processing unit(s) 110 and the memory 115 is quite flexible. In some examples, multiple processing units (e.g. multiple processors) may be used to perform gesture detection described herein. In some examples, a single processor may be used. In some examples, the information shown in FIG. 1 as encoded on memory 115 may be encoded on multiple computer readable media in communication with the device 100, rather than on a single computer readable medium. Moreover, while FIG. 1 illustrates processing unit(s) 110 that may execute instructions encoded on the memory 115, it is to be understood that in some examples, some or all of the gesture detection functionality may be performed in hardware and/or firmware (e.g. utilizing custom circuitry to perform some or all of the computations).

The memory 115 includes executable instructions for gesture detection 117. The executable instructions for gesture detection 117, when executed by the processing unit(s) 110, cause the processing unit(s) 110 to perform examples of gesture detection described herein. In this manner, the device 100 may be referred to as being programmed to perform gesture detection. The executable instructions for gesture detection 117 may be provided on the device 100 as an application operable on the device 100, and/or the executable instructions for gesture detection 117 may form a portion of an operating system operable on the device 100. The memory 115 may further include one or more stored gesture signature(s) 119. Again, it is to be understood that in some examples the executable instructions for gesture detection 117 and the gesture signature(s) may be provided on different computer readable media (e.g. different memories). The gesture signature(s) 119 may be stored values of features, and/or rules, that are used by the processing unit(s) 110 executing the executable instructions for gesture detection 115 to classify gestures.

The device 100 may include any number of input/output components 120 that may be provided to make inputs to the device 100 and/or receive outputs from the device 100. Examples of such input/output components 120 include, but are not limited to, ports such as those compatible with USB, micro USB, Micro SD, HDMI, and/or power ports, buttons, knobs, displays, speakers, and microphones.

The device 100 includes antenna 105. Any number of antennas may be included, with two more additional antennas 106 and 107 shown in FIG. 1. Four antennas are provided in some examples. The antenna 105 may be used to transmit communication signals from the device 100. For example, data may be transmitted from the device 100 in accordance with functions the device may be performing (e.g. voice or data transmissions in accordance with cellular and/or Wi-Fi communication protocols, such as but not limited to GSM, CDMA, WCDMA, TD-SCDMA and LTE signals, sometimes referred to as 2G, 3G, 4G in cellular networks). The same antenna and/or other antennas (e.g. the antennas 106 and 107) may receive reflections of the signal transmitted by the antenna 105. For example, the antenna 105 may be a transmit antenna, and the antennas 106 and 107 may be positioned proximate the transmit antenna such that they receive reflections of a communication signal transmitted by the antenna 105. In this manner, each antenna may be positioned to provide a distinct propagation path between a respective antenna and a transmitted signal source (e.g. the antenna 105). It will be appreciated that where a same antenna is used to both transmit a signal and receive reflections of that signal, a directional coupler, circulator, diplexer or other hardware may be used to separate the transmit and receive signals.

Generally, one or more antennas (e.g. antennas 105-107) may be provided to receive communication signals. The executable instructions for gesture detection 117 may provide instructions for detecting a gesture based on amplitude variations in the communication signals received on one or more of the antennas (e.g. antennas 105-107). The spatial separation between antennas, and in some examples directionality of the antennas, may be used in detecting gestures as described herein. Accordingly, one or more of the antennas 105-107 may be directional. One or more of the antennas 105-107 may have spatially distinct sensitivity patterns (such sensitivity patterns are often referred to as the radiation pattern of the antenna due to the reciprocity principle in antennas). One or more of the antennas 105-107 may be implemented using loop antennas.

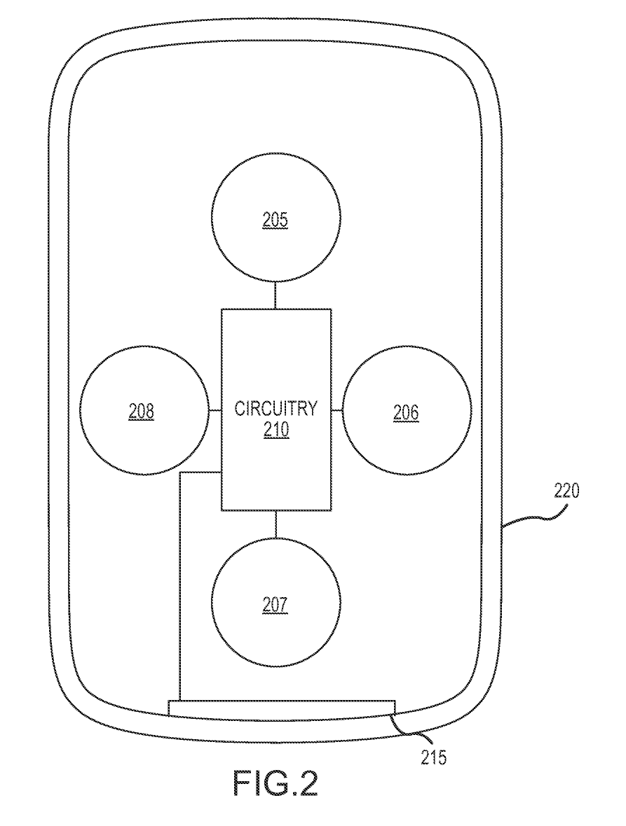

FIG. 2 is a schematic illustration of an example antenna design which may be included in a case in examples described herein. The antenna design includes antennas 205-208, circuitry 210, circuit board 220, and electrical connector 215. The components shown in FIG. 2 may be included in a case which may enclose at least a portion of a mobile device (e.g. the device 100 of FIG. 1). In some embodiments the case may be formed by the enclosure of the mobile device itself. In other embodiments, the case may be formed as a separate structure which is snapped or latched onto the case of the mobile device. In further embodiments, the case may be sold separately from the mobile device as an aftermarket addition.

Two of the antennas may be used, for example, to implement the antennas 106 and 107 of FIG. 1. While in some examples, one of the antennas 205-208 may be used to transmit data from a device, in some examples a different antenna (e.g. an antenna native to the device such as the antenna 105 of FIG. 1) may be used to transmit data, while the antennas 205-208 may be used to receive reflections of a signal transmitted by the device (e.g. the device 100).

The antennas 205-208 may be in electronic communication with circuitry 210 which may provide signals to and/or from the antennas 205-208 and the electrical connector 215. The electrical connector may interface with an electrical port of the device (e.g. an input/output component of the input/output components 120 of FIG. 1). For example, the electrical connector may be a USB connector that may interface with a USB port on the device 100. In some embodiments the electrical connector 215 may comprise a wireless connection such as a Bluetooth or Bluetooth low energy (“Bluetooth Smart”) connection. The four antennas 205-208 (e.g., top, down, left, and right) may allow the system to capture the signal variations caused by gestures (e.g. hand movements) from multiple directions around the device.

Each of these antennas 205-208 may be implemented using a directional antenna pointing to a distinct direction. In some embodiments the antennas 205-208 may be implemented using loop antennas. In other embodiments the antennas 205-208 may be implemented using other types of antennas such as patch antennas, dipole antennas, slot antennas, or combinations thereof with a reflector element. The circuitry 210 may include receiving channel circuitry, such as an RF power detector which may be connected to each of the antennas 205-208. In some embodiments the circuitry 210 may include a logarithmic detector, while in other embodiments the circuitry 210 may include a square-law detector. In further embodiments the circuitry 210 may include a demodulator such as an I/Q demodulator. In some embodiments the demodulator may demodulate the signal from the antennas 205-208 with reference to a reference signal obtained via a direct path from the transmitting circuitry of the mobile device.

The RF power detector may be implemented using, for example the AD8361 power detector manufactured by Analog Devices Inc. In some examples where CDMA, WCDMA, TD-SCDMA and/or LTE signals are used to detect gestures, ANALOG DEVICE'S ADL5903 may be used. In some examples, to avoid high output voltage (corresponding to high output power at the port of antennas 205-208), which may damage circuitry 210, the resonant frequency of the antennas 205-208 is provided to mismatch with the transmitted signal (e.g. GSM signal). In other embodiments an attenuator such as a resistive pi-network or t-network may be employed to reduce the signal power from the ports of the antennas 205-208 prior to providing said signals to the circuitry 210. In some embodiments, the RF power detector or demodulator may produce a time varying DC voltage that is related to the amplitude of the incident radio frequency signal at the input of the detector or demodulator. In some embodiments, circuitry 210 includes an analog-to-digital converter, or ADC, to convert the aforementioned time varying voltage into a sequence of sampled values proportional to that voltage. In some embodiments, the ADC may be integrated into the same integrated circuit as a microprocessor or microcontroller which is also included in circuitry 210, or in the mobile device itself.

In an example utilizing GSM signals, the resonant frequency of the antennas 205-208 is implemented around 1.4 GHz. The radius of loop antennas 205-208 is 1 cm and its circumference is close to ¼ of the GSM wavelength. The radius may be calculated to include a correction factor for the dielectric constant of the circuit board 220. While an array of directional antennas may be advantageous in allowing for discrimination between particular 3D gestures, examples described herein may generally be used without a custom antenna design. The antenna arrangement may affect what gestures the system is able to classify (e.g. discriminate between). In some examples utilizing existing antennas, it may be that only 1D or 2D gestures may be detected.

The antennas 205-208 and circuitry 210 may be provided on a circuit board 220 (or other substrate), which may be integrated into a case for a device. The case may at least partially enclose the device. Each antenna 205-208 in the example of FIG. 2 is provided on an edge of the PCB board 220 and connected the circuitry 210 (e.g. RF power detector) located at the center of the PCB 220. Since every antenna has a unique radiation pattern, different signal intensity fluctuation patterns may be obtained from the different antennas when a user or other entity is performing gestures. In some examples, the circuit board 220 or other substrate may further include a ground plane associated with the antennas 205-208. The ground plane may be provided on a back of the PCB 220 and may enhance the difference in radiation patterns of the antennas. In some embodiments, the ground plane may be an integral part of the antennas 205-208. In further embodiments, the ground plane may include a conductive coating or material applied to the case.

Generally, antennas may be provided which have different directionality (e.g. radiation patterns). The use of different directionality of the antennas may aid in gesture recognition in that each antenna may have a different sensitivity to gestures in particular locations with respect to the mobile device. Thus, the amplitude modulations received from the group as a whole may be better able to classify gestures given the known directionality of the antennas. In designing an antenna array for examples described herein, antenna radiation patterns may be simulated to show their distinct response patterns (sometimes referred to as radiation patterns because of the reciprocity principle of antennas) and ensure each may perceive a received signal through a unique propagation path. Antenna positions and directionality may be selected in accordance with an interaction space defined by the sensitivity array of the combination of antennas. In the example of FIG. 2, the antenna 205 may be provided having a directionality more sensitive to gestures made at a top of a device, the antenna 206 may be provided having a directionality more sensitive to gestures made at a right of a device, the antenna 207 may be provided having a directionality more sensitive to gestures made at a bottom of a device, and the antenna 208 may be provided having a directionality more sensitive to gestures made at a left of a device. In this manner, for example, larger amplitude modulations at the antennas 208 and 207 than the amplitude modulations at the antennas 205 and 206 may indicate a gesture at the bottom left of the device.

Generally, the receiving antennas may receive amplitude modulated signals in their respective propagation paths. Combining the signals from multiple antennas, a unique pattern may be detected corresponding to particular gestures.

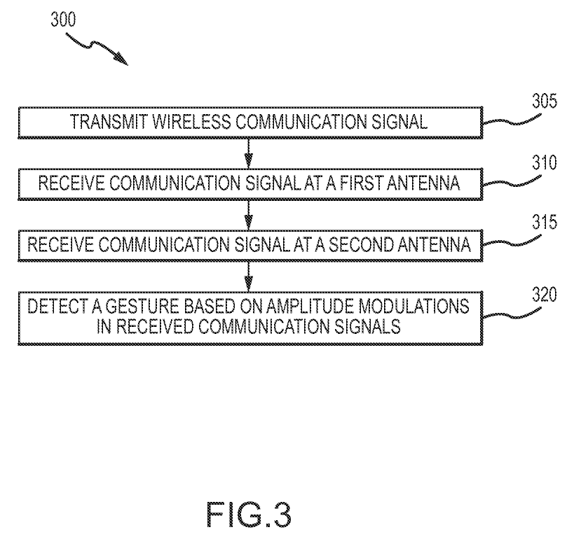

FIG. 3 is a flowchart illustrating an example method according to examples described herein. The example method 300 may include transmitting a wireless communication signal in block 305, receiving a communication signal at a first antenna in block 310, receiving a communication signal at a second antenna in block 315, and detecting a gesture based on amplitude modulations in the received communication signals in block 320.

A wireless communication signal may be transmitted in block 305. The wireless communication signal may be generally transmitted by any wireless device, including the device 100 of FIG. 1, using for example antenna 105. Any of a variety of wireless communication signals may be used including, but not limited to cellular communication signals such as GSM signals or Wi-Fi signals.

GSM signals may be advantageously used in examples described herein. Generally, GSM networks operate in several carrier signal bands (e.g., AT&T using 850 MHz/1900 MHz, while T-Mobile using 1900 MHz). GSM signals are frequency-shifting modulated signals that use two different frequency components to transmit logical 1's and O's, a technique called Gaussian Filtered Minimum Shift Keying (GMSK). Comparing to other amplitude-shift keying and on-off keying signals, GMSK signals may maintain stable amplitudes when the transmitter's gain is constant. As a minimum shift keying, GMSK generally encodes each bit as a half sinusoid, which reduces the power fluctuation caused by non-linear distortion. The envelope of a GMSK signal is independent of the transmitted data; that is, the magnitude of the fading propagation channel may be measured without knowing the content and encryption mode of transmitted data. Given the stability, GSM signals may be advantageously used for gesture detection. However other modulation types such as the CDMA modulation used in other 3G and 4G networks may also be used for gesture detection.

A communication signal (e.g. a GSM signal) may be received at a first antenna in block 310. For example, a communication signal may be received at the antenna 106 in FIG. 1. Any of a variety of types of communication signal may be received, such as GSM signals or Wi-Fi signals. The signal may be received in some examples by a same device which transmitted the signal. For example, the received signal may be a reflection of the signal transmitted in block 305. A communication signal may be received at a second antenna in block 315. For example, a communication signal may be received at the antenna 107 in FIG. 1. Any of a variety of types of communication signal may be received, such as GSM signals or Wi-Fi signals. The signal may be received in some examples by a same device which transmitted the signal. For example, the received signal may be a reflection of the signal transmitted in block 305. In this manner, each of multiple antennas may receive a different reflection of a transmitted signal.

In some examples, when a device (such as the device 100 of FIG. 1 which may be a mobile phone) is used to make a call or transmit data, the device transmits GSM pulses in block 305 to communicate with the station. Around the mobile phone, there are a number of propagation paths. Such paths start from the transmitting antenna of the device and end up at each receiving antenna (e.g. antennas 106, 107, which may be loop antennas). When a user or other entity moves their hand or other body part around the device, their skin, muscle and bones affect the character of the propagation path (e.g. Scatter Parameters, or S-Parameters) by absorbing or reflecting part of the signal. The absorption may reduce the signal intensity, while the reflection may generate a time varying amplitude of the reflected signal, as well as Doppler shifts. As a combination of the signals from all propagation paths, the received signals (e.g. received in blocks 310 and 315 of FIG. 3) will be changed by all the absorption, the time varying reflection amplitude, and Doppler-shifts. The outcome of these effects are amplitude-modulated signals that may be received in blocks 310 and 315. Examples described herein utilize the amplitude modulated signals for gesture recognition (e.g. in block 320).

A gesture may be detected based on amplitude modulations in the received communication signals in block 320. A user or other entity that performs a gesture in the vicinity of an electronic device may cause amplitude modulation with reflections of wireless communication signals received by antennas of that device. The pattern of amplitude modulation may be analyzed to detect the gesture.

Generally, when GSM signals are used for transmit and receipt in blocks 305, 310, and 315, the GSM pulses may be considered to non-uniformly sample the propagation channels by emitting energy into the propagation channel in staccato bursts. The Shannon sampling theorem for non-uniform sampling suggests that a band-limited signal can be reconstructed from its samples if the average sampling rate satisfies the Nyquist condition. Since the average frequency of the GSM pulses is nearly 80 Hz, which is more than twice the rate of gestures (which usually occur at tens of Hz), the propagation channel variation may be reconstructed using the received GSM pulses.

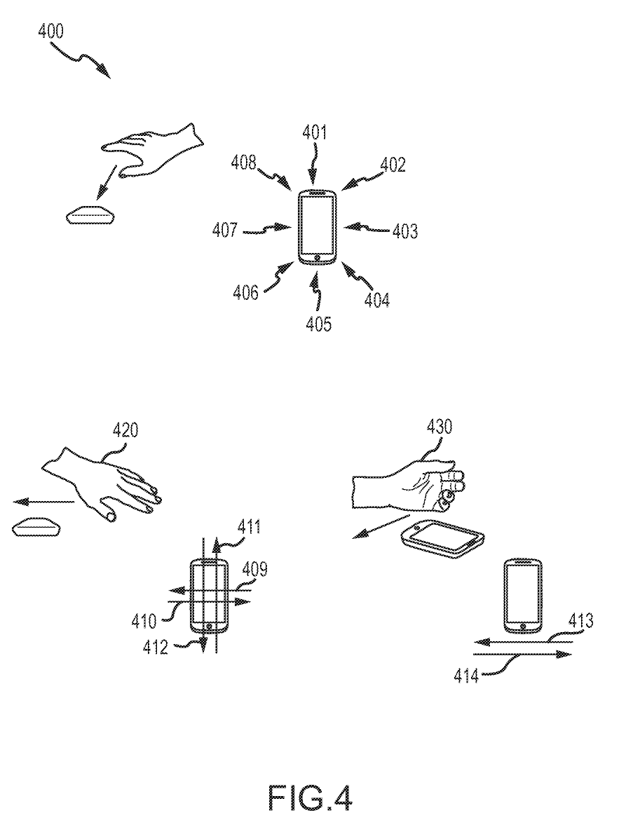

FIG. 4 is a schematic illustration of example gestures which may be detected in accordance with examples described herein. The gestures shown in FIG. 4 may be detected using, for example, the device 100 of FIG. 1 and/or the antenna design of FIG. 2. The gestures shown in FIG. 4 may be detected using methods described herein, such as the method 300 shown in FIG. 3.

Gestures shown in FIG. 4 are intended to be exemplary only, and other and/or different collection of gestures may be detected in other examples. Generally, use of multiple antennas receiving spatially different communication signals related to a gesture may facilitate directional detection of gestures, and the ability to classify different directional gestures is shown by the collection of gestures in FIG. 4. Gestures which may be detected generally include any gesture which may disturb signal propagation between a transmitting and one or more receiving antennas of the device, and may include gestures made in-air both above and/or around a device.

Different taps 400 may be detected. A tap may include a movement of a user's hand toward a particular portion of a device, and the tap may or may not involve contacting the device. Taps may move toward and/or contact a corner of a device or a side of a device in some examples. Examples of directional taps that may be detected (e.g. classified) include, but are not limited to, a tap on and/or toward a top side 401 of a device, a tap on and/or toward a top right side 402 of a device, a tap on and/or toward a right side 403 of a device, a tap on and/or toward on a bottom right side 404 of a device, a tap on and/or toward on a bottom side 405 of a device, a tap on and/or toward a bottom left side 406 of a device, a tap on and/or toward a left side 407 of a device, and a tap on and/or toward a top left side 408. In some embodiments a tap may be classified at least in part on the basis of a significant increase in reflected energy during the time the user's hand is closest to a particular antenna on the mobile device. Thus a sharp increase in the reflected signal would likely correspond to a tapping gesture.

Hover gestures 420 may be detected in accordance with examples described herein. Hover gestures 420 may involve a user's open palm hovering above a device and moving in a particular direction, with the palm generally parallel to a screen of the device. In some examples, hover gestures may be made in a plane parallel to a side of the device. Hover gestures which may be detected include, but are not limited to, a hover towards a left across a device 409, a hover towards a right across a device 410, a hover towards a bottom of a device 411, and a hover towards a top of a device 412. In some embodiments a hover gesture may be classified at least in part on the basis of a significant increase in reflected energy that has a slower onset and decay when compared to e.g. a tap gesture.

Slide gestures 430 may be detected in accordance with examples described herein. Slide gestures 430 may involve a user's open palm moving above a device in a particular direction, with the palm generally perpendicular to a screen of the device. In some examples, slide gestures may be made in a plane parallel to a side of the device. Slide gestures which may be detected include, but are not limited to, a slide to a left of the device 413 and a slide to a right of the device 414. In some embodiments a slide gesture may be classified at least in part on an increase in reflected energy at one antenna followed by an increase in reflected energy at another antenna as the slide gesture progresses.

Accordingly, gestures which may be detected (e.g. classified) in accordance with examples described herein include 3D gestures. For example, devices described herein may be able to discriminate between a touch (e.g. a gesture made by moving toward a device) from a slide (e.g. a gesture made by moving across a device). The ability to detect 3D gestures may be facilitated by the receipt of multiple reflections at spatially separated antennas.

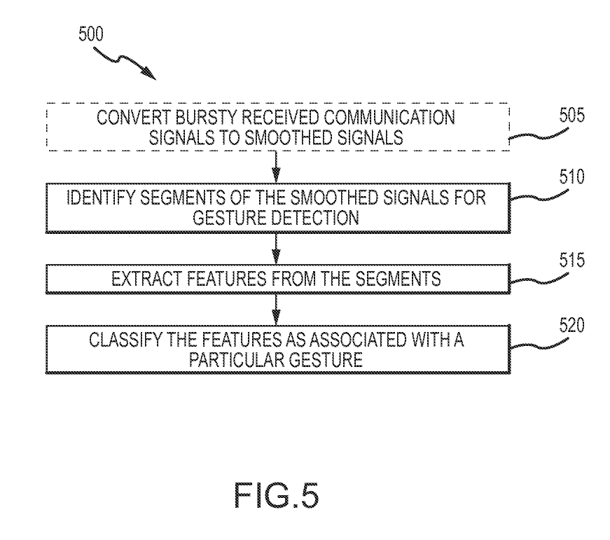

FIG. 5 is a flowchart illustrating a method according to examples described herein. The method 500 includes optionally converting bursty received communication signals into smoothed signals in block 505. In block 510, segments of smoothed communication signals may be identified for gesture detection. In block 515, features may be extracted from the segments. In block 520, the features may be classified as corresponding to a particular gesture. The method 500 may be performed by the device 100 of FIG. 1. For example, the executable instructions for gesture recognition shown in FIG. 1 may include instructions for performing some or all of the actions described with reference to FIG. 5.

In optional block 505, bursty received communication signals may be converted into smoothed signals. For example, GSM communication signals may be bursty in that the signals may not be continuous. The bursty signals may be converted into smoothed signals, for example by sampling and interpolating the signal to generate a smoother signal. Such an interpolation may be performed by finding the peaks in the observed signal followed by straight-line or linear interpolation between adjacent peaks. In other embodiments such interpolation may be performed by a low pass filtering operation. In some embodiments the interpolation may be performed by analog circuitry while in other embodiments the interpolation may be performed by a series of digital operations. The received communication signals received converted in block 505 may be received reflections of a signal transmitted by a device, such as GSM signals, as described herein with reference to FIGS. 1-4.

In order to allow multiple users to share the same frequency channel, GSM uses Time Division Multiple Access (TDMA), which divides the bandwidth into different slots. In turn, actual GSM signals include a sequence of bursts. The sequence of bursts generally refers to multiple data transmission intervals interspersed with intervals of no transmission. The duty cycle and the intervals between bursts may be determined by several factors, including the service provider's discretion, that is encrypted for security reasons. Without knowing the modulation details, the distribution of slots appears as the outcome of a random process. In addition, received GSM signals may be mixed with other communication signals (e.g. Wi-Fi and Bluetooth). To leverage these random signal bursts for gesture recognition, examples described herein may filter unnecessary signals and convert the bursty signals (e.g. GSM signals) into smoothed signals (e.g. continuous waveforms). Accordingly, signals may be filtered in block 505, such as by filtering out signals other than reflections of a transmitted signal (e.g. filtering Wi-Fi and/or Bluetooth signals out of a received signal to leave GSM signals). The filtered signals may be interpolated to provide smoothed signals (e.g. continuous signals). Such filtering may be performed using analog circuitry, while in other embodiments it may be performed in a digital filter. In some examples, the duration of each GSM pulse is close to 0.67 ms (e.g., 12 samples at a sampling rate of 18 KHz). Since Wi-Fi and Bluetooth signal have relatively shorter pulse widths (e.g., less than 8 samples across gestures), a threshold of the pulse width may be set (e.g. 8 samples) to filter these unnecessary signals. Accordingly, generally pulses having widths less than a threshold may be filtered from a received communication signal in 505 prior to smoothing. This may allow for the removal of unwanted signals from desired signals. In other examples, filtering may be to filter pulses having widths over a threshold when shorter pulse signals are desired for use in gesture detection. A fixed threshold (e.g. 80 mV in one example) may be used to identify a falling and rising edge of the pulses.

Some received communication signals may have a fluctuation in power density unrelated to gesture detection. Such unrelated amplitude fluctuations may be normalized in block 505 as well. For example, a GSM system usually adjusts its transmitting power to maintain a stable gain in a fluctuating environment and in turn affects the receiving power density received in block 505 or in blocks 310 and 315 of FIG. 3. Such fluctuation may be undesirable in gesture recognition as two signal patterns of the same gestures may appear completely different owing to fluctuations in the transmit power. To adapt to this fluctuation, the received signals may be normalized corresponding to the transmitting power. For example, signals may be captured for a set period of time (e.g. 20 minutes) when gestures are not being performed, and the captured transmit signal power and receiving gain stored in a table. The table may be stored by the receiving device (e.g. the device 100 of FIG. 1, for example in the memory 115). When receiving a GSM pulse at blocks 310 and 315 of FIG. 3 and/or block 505 of FIG. 5, the device may measure transmitting power and use it to find the corresponding receiving gain in the stored table. The average voltage of the received pulse (e.g. GSM pulse) may be divided with this gain. In this manner, the power variation due to fluctuating transmitting power may be normalized. It is noted that there may be a limited number (e.g. 16) of different levels of transmitting power, so maintaining such a table may not be cost- or resource-prohibitive. The table may be built manually or through a calibration process performed at a particular time, e.g. device or application startup. In other embodiments, a signal may be obtained from the mobile device indicating the transmitted power level and this signal may be used to normalize the received signals.

During operation, once the received signals have been filtered to retain only pulses of appropriate widths (e.g. GSM pulses), an average of several (e.g. 6) middle points may be calculated as the height of the pulse and used to represent the received magnitude in the respective antenna. The discrete sequence may be interpolated in block 505 to construct the smoothed signal (e.g. continuous wave).

Multiple signals may be received (e.g. at corresponding multiple antennas) and optionally filtered, normalized, and smoothed in block 505 into respective smoothed signals.

In block 510, segments of smoothed communication signals may be identified for gesture detection. In one example, a sliding window segment of 2.5 seconds was used to capture a hand gesture. The segments may be detected based on amplitude modulations occurring in the smoothed communication signals.

Segments of each of multiple smoothed communication signals may be identified in block 510 (e.g. segments of signals received by each of a plurality of antennas).

The smoothed signals may be noisy in some examples, and may not in some examples directly be used for gesture detection. Accordingly, signal processing techniques may be used to identify and extract segments of the signals corresponding (or likely to correspond) to gesture activity in block 510.

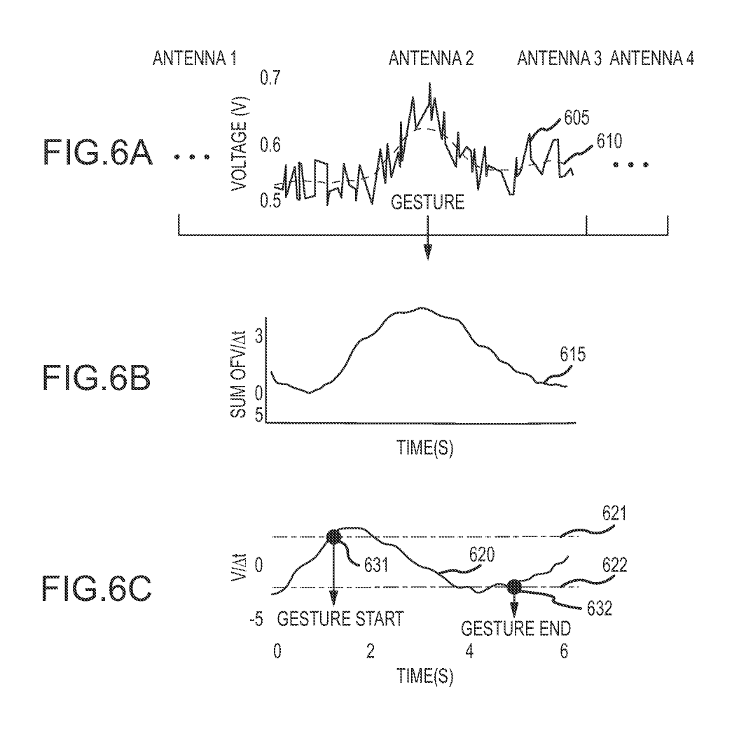

FIGS. 6A-C are graphs illustrating an example process of identifying a signal segment corresponding to a gesture. In FIG. 6A, for each of multiple antennas' signals a filter (e.g. a Savitzky-Golay (SG) filter or a finite impulse response (FIR) filter) may be applied to reduce noise in the signal. In FIG. 6A, the received signal in block 510 of FIG. 5 is shown as signal 605, while signal 610 shows the signal 605 after filtering with an SG filter using a window size of 301. The SG filter is able to denoise the signal while generally maintaining the shape of the original signal 605. An equivalent behavior would be expected from an FIR filter.

The derivative of the filtered curve may be taken to capture significant signal variations caused by a gesture. In some examples, segments may be extracted from each signal received at a plurality of antennas. In some examples, however, signals from multiple antennas are combined to result in a fewer number of signals for segmentation and feature extraction. In FIG. 6B, for example, the absolute value of the derivative curves from multiple antennas (e.g. the four antennas shown in FIG. 2) are summed to arrive at summed derivative signal 615. In this manner, a peak may be identified which represents a possible gesture.

In FIG. 6C, another first derivative of the signal 615 is performed, resulting in the signal 620, and used to identify a segment corresponding to a gesture. A global threshold may be used to identify a segment corresponding to a gesture. The threshold may be selected with reference to training sequence results, or may be set to an absolute value. Generally, a segment of the signal may be identified between when the second derivative signal 620 exceeds a positive threshold 621 and when the second derivative signal 620 falls below a negative threshold 622. Accordingly, in FIG. 6C, a segment may be identified (e.g. extracted) between the points 631 and 632.

Returning to discuss gesture detection with reference to FIG. 5, in block 515, features may be extracted from the segments. For example, features may be extracted from the segment of signal 610 corresponding to the time period between 631 and 632 of FIG. 6. The features may generally include amplitude modulations of the signals occurring in the segments. Features may be extracted from each of the segments identified in block 510 in some examples (e.g. features may be extracted corresponding to signals received at each of a plurality of antennas).

In some examples, feature extraction may take place using a truncated window of samples (e.g., 4500 samples corresponding to 2.5 sec in some examples), which may be centered at the midpoint of a segment. These samples may be used as the feature set, which describes the curve of the received signal. In some examples, features are extracted for each of the antennas receiving a signal to generate a combined feature vector with features from each of the antennas. The feature vector has 18,000 elements in one example utilizing 4 antennas. This feature vector represents a unique pattern for different gestures. The feature vector may be reduced by down sampling the feature vector to a reduced number of elements (e.g. 80 elements corresponding to 20 elements per antenna).

In block 520, the features may be classified as corresponding to a particular gesture. The classification may be based on features from several of the received signals (e.g. using features corresponding to signals received from multiple antennas). The classification may be based on a spatial relationship between the antennas (e.g. the spatial relationship between antennas may be related to the difference in features used to classify gestures).

In some examples, machine learning techniques may be employed to classify gestures (e.g. using Weka). In Weka, a 14-fold cross validation may be performed using a Support Vector Machine with PUK kernel. The PUK kernel may have the flexibility to vary between a Gaussian, Lorentzian shape and others, and therefore can be used as a universal kernel in some examples. Since the signal pattern of a gesture may vary from person to person (e.g., waving the hand at different speeds), this PUK kernel may be able to better adapt to signals that have various shapes.

In some examples, gestures may be classified by comparing the features with stored gesture signatures (e.g. the gesture signatures 119 in FIG. 1). A gesture signature having a best match with the features received may be selected as the gesture corresponding to the received signal.

The detected gesture may be used to control the device, such as the device 100 of FIG. 1. For example, performance of a particular gesture may be used to adjust a volume of a device audio or video playback, scroll through user interface options, start or stop applications on the device, answer or ignore telephone calls or other messages received by the device, mute a telephone call, or generally any other action which may be taken responsive to a detected gesture.

In some examples, gestures may be used to control a phone when a user receives phone call in a non-appropriate situation (e.g., during a meeting, reading in a library). Instead of taking the phone out of her pocket, she can just use hand gesture to respond to the incoming call. Different gestures may be used, for example, to control three modes: enable silent mode with, e.g., a downward gesture towards the phone, send predefined text with, e.g., a right swipe gesture, and decline incoming calls by, e.g., tapping on the phone

In some situations, it may be difficult for a user to touch the screen in order to navigate through the phone. To accommodate user inputs in such cases, in examples described herein a user can perform a gesture (e.g. an upward gesture) to enable scrolling while following a recipe. In addition or instead, a user can perform in-air gestures to control their music listening experience, which may be advantageous in a variety of touch unfriendly situations. For example, while taking a shower, a user can easily control music volume with a gesture (e.g. a tapping gesture) and switch between songs with another gesture (e.g. a swipe gesture).

Besides accommodating touch unfriendly situation, control using gestures may also accommodate user's needs in different situational impaired scenarios such as driving or flying. Users may easily switch, for example, between map, music, and messaging applications with gestures (e.g. left and right swipe gestures) without having to touch specific location of a device, including a display in the vehicle, train, or airplane. Once selected, any application specific feature (e.g., map zoom in/out, turn GPS on/off) can then be navigated using gestures (e.g. inward or outward swipe gestures). These gestures may be easily be performed without even looking at the device, which may reduce user's secondary task burden and allow her to focus more on the primary driving or flying task.

Furthermore, because the gesture sensing approach disclosed herein does not rely on direct contact between the user and a mobile device, nor does it require a line of sight from the user to the device, the aforementioned gestures may be performed while the mobile device is separated from the user by some distance, including when separated by any material which is transparent to radio frequency energy, such as textiles, leather, plastic, wood, etc. In such cases the gesture sensing approach functions when the mobile device is in a user's pocket or in a user's handbag, on a table or desk, inside a drawer, compartment, or cubbyhole of furniture, etc.

From the foregoing it will be appreciated that, although specific embodiments of the disclosure have been described herein for purposes of illustration, various modifications may be made without deviating from the spirit and scope of the disclosure.

What is claimed is:

1. A device comprising:
a first antenna configured to receive a first communication signal;
a second antenna configured to receive a second communication signal; and
at least one processing unit in communication with the first and second antennas, the at least one processing unit configured to receive the first and second communication signals, wherein the at least one processing unit is further configured to:
determine an amplitude modulation associated with each of the first and second communication signals; and
detect a gesture based on the amplitude modulation associated with each of the first and second communication signals.

2. The device of claim 1, wherein the first and second communication signals are respective reflections of a wireless communication signal.

3. The device of claim 1, wherein the first antenna, the second antenna, or both, are directional.

4. The device of claim 1, wherein the first and second antennas have spatially distinct sensitivity patterns.

5. The device of claim 1, wherein at least one of the first or second antennas include at least one loop antenna.

6. The device of claim 1, further comprising one or more additional antennas, also connected to the at least one processing unit, the at least one processing unit further configured to determine amplitude modulations for each additional signal provided by the one or more additional antennas and the gesture is detected based, at least in part, on the amplitude modulations for each additional signal.

7. The device of claim 1, further comprising a transmit antenna positioned proximate the first and second antennas.

8. The device of claim 7, wherein the first and second communication signals are reflections of a signal transmitted by the transmit antenna.

9. The device of claim 6, wherein each of the first, second, and one or more additional antennas are positioned to provide a unique propagation path between a respective antenna and a transmitted signal source.

10. The device of claim 1, wherein at least one of the first and second antennas are further configured to transmit a transmit signal.

11. The device of claim 10, further comprising a directional coupler or a circulator configured to separate the transmit signal from the first or second communication signal.

12. A method comprising:
transmitting a bursty communication signal;
receiving at least one reflection of the bursty communication signal with at least one antenna;
converting the at least one reflection of the bursty communication signal into a smoothed signal;
classifying the smoothed signal as corresponding to a gesture, based, at least in part, on an amplitude modulation associated with the smoothed signal.

13. The method of claim 12, wherein the bursty communication signal comprises a GSM signal.

14. The method of claim 12, wherein the bursty communication signal comprises multiple data transmission intervals interspersed with intervals of no transmission.

15. The method of claim 12, wherein the receiving comprises receiving a plurality of reflections of the bursty communications signal at respective antennas of a plurality of antennas; wherein the converting comprises converting each of the plurality of reflections into a respective smoothed signal; and wherein the classifying is further based, at least in part, on amplitude modulations associated with a plurality of the smoothed signals.

16. The method of claim 15, wherein the classifying is further based, at least in part, on a spatial relationship between the plurality of antennas.

17. The method of claim 12, wherein the gesture comprises a change in proximity between a user's hand and one or more portions of a mobile device.

18. The method of claim 12, further comprising extracting features from the smoothed signal, and wherein the classifying is based, at least in part on the features.

19. The method of claim 12, wherein the gesture comprises a 3D gesture.

20. The method of claim 12, wherein the classifying is performed by a device, and wherein the gesture comprises a tap toward a corner of the device, a tap on a side of the device, a hover in a plane parallel to a side of the device, or a swipe in a plane parallel to a side of the device.

21. A system comprising:
a mobile device, the mobile device comprising:
a first antenna configured to transmit a wireless communication signal;
at least one processing unit coupled to the first antenna;
an electrical port coupled to the at least one processing unit;
at least one computer readable medium coupled to the at least one processing unit and encoded with instructions executable by the at least one processing unit; and
a case configured to at least partially enclose the mobile device, the case comprising:
a plurality of antennas;
an electrical connector coupled to the plurality of antennas, wherein the electrical connector is configured to connect with the electrical port to electrically connect the plurality of antennas to the at least one processing unit;
wherein the instructions executable by the at least one processing unit comprise instructions for:
receiving reflections of the wireless communication signal at the plurality of antennas;
detecting a gesture based on amplitude modulations in the reflections of the wireless communication signal.

22. The system of claim 21, wherein the wireless communication signal comprises a mobile telephony or mobile data signal, and wherein the instructions further include instructions for smoothing the reflections of the wireless communication signal into respective smoothed signals.

23. The system of claim 21, wherein the gesture comprises a 3D gesture.

24. The system of claim 21, wherein the case further comprises a ground plane associated with the plurality of antennas.

25. The system of claim 21, wherein the instructions for detecting a gesture further comprise instructions for detecting the gesture based on a spatial relationship between the plurality of antennas.
